(19) United States
(12) Patent Application Publication
(10) Pub. No.: US 2025/0037395 A1
(43) Pub. Date: Jan. 30, 2025

(54) AR TECHNOLOGY BASED DECORATION SYSTEMS AND METHODS

(71) Applicant: Mixtiles Ltd., Tel Aviv (IL)

(72) Inventors: Arad SEROUSSI, Tel Aviv (IL); David KATZ, Tel Aviv (IL)

(21) Appl. No.: 18/835,288

(22) PCT Filed: Feb. 9, 2023
(86) PCT No.: PCT/IB2023/051176

§ 371 Date: Aug. 1, 2024

Related U.S. Application Data
(60) Provisional application No. 63/308,149, filed on Feb. 9, 2022.

(51) Int. Cl. G06T 19/00; G06Q 30/0601

(52) U.S. Cl. CPC G06T 19/006; G06Q 30/0631; G06T 2200/24; G06T 2210/04

(57) ABSTRACT

An interior decoration system operable by a user includes a collecting module for identifying an environment data in a reality viewpoint of the user including at least one environment information collector; at least one processing module for receiving the environment data and identify an area candidate for design; an input module for receiving optional input from the user to manipulate the area candidate; and a module for augmenting the reality viewpoint with a virtual masking of said identified candidate area for design, presenting the augmented view to the user and configured to provide at least one suggestion on one or more candidate product categories suitable for the identified candidate area for design. The module for augmenting presents to said user an image of at least one virtual product from the candidate product categories, thereby providing an augmented reality viewpoint including the virtual product in said identified candidate area.

### CROSS-REFERENCE TO RELATED APPLICATIONS

This application claims priority to U.S. Provisional Application No. 63/308,149 filed on 9 Feb. 2022, the disclosure of which is incorporated herein, in its entirety, by this reference.

### TECHNOLOGICAL FIELD

The disclosed subject matter relates to the field of layout apps for interior design and more particularly to methods and systems for using an interior decoration design system based on augmented reality (AR) technology for presenting objects placed in AR scene.

### BACKGROUND

The following references may be considered to be relevant as background art to the presently disclosed subject matter.

CN106791778A discloses an AR (Augmented Reality) technology based interior decoration design system. The AR technology based interior decoration design system comprises an image information collecting unit for collecting and recording lighting information, interior azimuth information and original equipment information in a to-be-decorated room; a modularized editing unit for receiving data transmitted by the image information collecting unit and performing modularized editing on the original scenery information and environment information in the room; and an AR presenting unit. The AR technology based interior decoration design system disclosed in CN106791778A can design and show the interior decoration style vividly in advance by adopting the AR technology, so that a user can have a feeling of living in the room more really in advance; and further improvement also can be carried out in a decoration process.

US2020118339A1 discloses a system for augmented reality layout includes an augmented reality layout server and an augmented reality layout device, including a processor; a non-transitory memory; an input/output; a model viewer providing two-dimensional top, three-dimensional, and augmented reality views of a design model; a model editor; a model synchronizer, which aligns and realigns the design model with a video stream of an environment; a model cache; and an object cache. Also disclosed is method for augmented reality layout including creating model outline, identifying alignment vector, creating layout, verifying design model, editing design model, and realigning design model.

WO2018099400A1 discloses to an augmented reality-based interior design system, comprising: an environmental information collector; a modeling module, comprising a scene simulator and an object simulator, the scene simulator generating a virtual scene module on the basis of three-dimensional information collected by the environmental information collector; a display module, displaying the virtual object module over a real-world scene in a superimposing manner or displaying the virtual scene module and the virtual object module over a real-world scene in a superimposing manner; and an input module, operated by a user to change the spatial attribute and/or form attribute of the simulated object. The described augmented reality-based interior design system, by using the environmental information collector to collect the three-dimensional information of the user's home and modeling on the basis of the three-dimensional information, can be more adaptable to the particular environment and requirements of the user.

US2021133850A1 discloses techniques for providing a machine learning prediction of a recommended product to a user using augmented reality include identifying at least one real-world object and a virtual product in an AR viewpoint of the user. The AR viewpoint includes a camera image of the real-world object(s) and an image of the virtual product. The image of the virtual product is inserted into the camera image of the real-world object. A candidate product is predicted from a set of recommendation images using a machine learning algorithm based on, for example, a type of the virtual product to provide a recommendation that includes both the virtual product and the candidate product. The recommendation can include different types of products that are complementary to each other, in an embodiment. An image of the selected candidate product is inserted into the AR viewpoint along with the image of the virtual product.

It will be appreciated that acknowledgement of the above references is not to be inferred as meaning that these are in any way relevant to the patentability of the presently disclosed subject matter.

### GENERAL DESCRIPTION

In accordance with an aspect of the disclosed subject matter there is provided an interior decoration system operable by a user, comprising:
a collecting module for identifying an environment data in a reality viewpoint of the user, comprising at least one environment information collector;
at least one processing module configured to receive the data from the collecting module and identify an area candidate for design;
an input module configured to receive optional input from the user to manipulate the area candidate for design;
a module configured for augmenting the reality viewpoint with a virtual masking of said identified candidate area for design, presenting the augmented view to the user and configured to provide at least one suggestion on one or more candidate product categories suitable for the identified candidate area for design;
the module for augmenting said reality viewpoint being further configured to present to said user an image of at least one virtual product from the one or more candidate product categories, thereby providing an augmented reality viewpoint of said reality viewpoint comprising the at least one virtual product in said identified candidate area for design.

In accordance with another aspect of the disclosed subject matter, there is provided an interior decoration method for providing an augmented reality viewpoint to a user, the method comprising:
identifying and collecting, by at least one module, a real-world environment data in a reality viewpoint of the user, using at least one environmental information collector for detecting and collecting two and/or three-dimensional information of the environment;
processing the data from the at least one information collector module to identify an area candidate for decoration;
augmenting the reality viewpoint with a virtual masking of the identified candidate area for decoration;
presenting the augmented reality viewpoint with the identified candidate area to the user and providing, using at least one processing module, at least one suggestion on one or more candidate product categories suitable for said identified candidate area for decoration; said predicting based on at least one of the suggested product categories being complementary to the identified reality viewpoint and at least a location, dimensions and characteristics of said identified candidate area.

In accordance with yet an aspect of the disclosed subject matter there is provided a system, the system comprising:
an image sensor configured to generate an image sequence comprising at least one image;
a display device;
one or more processing engines;
a data storing module;
wherein the one or more processing engines are configured to perform operations comprising:
   displaying on the display device the image sequence of a real-world environment;
   generating a virtual masking of a one or more designable area on the image of the real world environment as displayed, the virtual masking being generated by processing using at least one of a computer vision and classification processing engines the real-world environment data of the image sequence, analyzing and sensing boundary points of the real-world environment data in at least two dimensions, and identifying, using at least said boundary points, spatial attributes of the candidate virtual designable area, the virtual masking being displayed at least in two-dimensions, the virtual masking further configured to present product category based on said spatial attributes;
   transmitting, to a server (where the server as referred to herein can be e.g., local dataset or a remote server), a request specifying product category of items that have dimension values that fit the dimensions of the virtual masking of the designable area;
   displaying, on a user interface in the display device, one or more items matching the defined designable area;
   following a selection of an item from the one or more items, displaying, on the display device, a modified image sequence that shows the image sequence and one or more 3D renders of the selected item as arranged at the virtual masking.

In a further aspect of the disclosed subject matter a method is provided, the method comprising:
displaying, on a display device of a user device, an image sequence depicting a real-world environment, the image sequence generated using an image sensor of the user device;
generating, on the user device, a virtual masking of a one or more designable area on the image of the real world environment as displayed, the virtual masking being generated by processing the real-world environment data of the image sequence, analyzing and sensing boundary points of the real-world environment data in at least two dimensions, and identifying, using at least said boundary points, spatial attributes of the candidate virtual designable area in combination with design instructions provided to the system (e.g., aesthetic rules, interior design rules, etc.), the virtual masking being displayed at least in two-dimensions, the virtual masking further configured to present product category based on said spatial attributes;
transmitting, to a server, a request specifying product category of items that have dimension values that fit the dimensions of the virtual masking of the designable area generated on the user device;
displaying, on the user interface in the display device, one or more items matching the defined designable area; and
following a selection of an item from the one or more items, displaying, on the display device, a modified image sequence that shows the image sequence and one or more 3D renders of the selected item as arranged at the virtual masking.

Any one or more of the following features, designs and configurations can be applied to a system and method according to the aspects of the present disclosure, separately or in various combinations thereof:
the image sensor collects data comprising dimensions of the real world environment.
the image sensor is a camera.
the display device is a computing device.
a data collected and generated by the image sensor comprises image data of the real world environment, wherein physical dimensions are derived from the image data in the at least one image.
a data comprises 3D feature data, and further comprising determining dimensions of the real world environment based on the 3D feature data.
comprising a recommendation engine providing product recommendation based on the candidate product category.
comprising a recommendation engine selecting and providing product recommendation based on a profile of a system user.
comprising a recommendation engine selecting and providing product recommendation based on past purchase history of a system user.
further comprising a recommendation engine selecting and providing product recommendation based on merchant product availability.
the virtual masking or the one or more designable area being a generic representation of the at least one product from a product category presented based on the spatial attributes.
comprising allowing a user to manipulate the designable area.
comprising allowing a user to manipulate the designable area, wherein the manipulation comprises moving thereof, altering size and dimension, changing the proposed product category through an input module.
comprising a module allowing sharing the modified image sequence.
products proposed are determined based on algorithmic calculations of at least one of color matching to color palette in the real world environment; chosen by the user color scheme.
products are filtered by the algorithmic calculation based on a inputted or proposed color scheme.
Products are proposed based on the environmental features of the real world environment, including the dimensions, category, type, theme etc. of the environment.
one or more product categories are provided for the designable area recognized by the application as provided by the one or more processing engines.
one or more product categories are provided following an algorithmic calculation taking into account at least one of the position, dimensions, style and theme of the designable area recognized by the application.
the one or more product categories provided following an algorithmic calculation taking into account at least one of the position, dimensions, style and theme of the designable area recognized by the application, the algorithmic calculation further is configured to perform a classification and rating of the potential products suitable to the designable area and provide the user with the one or more product category with highest rating set by the system based on rules set for the algorithms performing the calculation. It will be appreciated that such rules could be related to interior design, safety, chosen theme, style, and the like.

It will be appreciated that further aspects and various embodiments and features pertaining to these or other aspects of the present subject matter are discussed in the description and illustrated in the drawings. Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

In order to better understand the subject matter that is disclosed herein and to exemplify how it may be carried out in practice, non-limiting examples of embodiments will now be described, with reference to the accompanying drawings, in which:

FIG. 1 is a block diagram of an example system illustrating exemplary components for suggesting recommended products in an AR environment, in accordance with some example embodiments of the present disclosure;

FIG. 2 is a block diagram of an example system operations for identifying and suggesting a designable area in an environment, in accordance with some example embodiments of the present disclosure;

FIG. 3 is an example flow diagram of selected method operations that occur when generating user interface suggestions for a virtual object in a real-world environment for placement in an AR view in accordance with some example embodiments of the present disclosure;

FIGS. 4A-4M show examples of simplified user interfaces for implementing the method in accordance with example of embodiments of the present disclosure;

FIG. 5 shows an example of the simplified user interface for checkout and purchasing of the selected products based on the implemented method in accordance with an example of the disclosed subject matter;

FIG. 6 shows an example of a user interface implementing the method in accordance with another example of the present disclosure; and

FIGS. 7A-7E show examples of visual field of a user using an application in accordance with an example of the disclosed subject matter.

### DETAILED DESCRIPTION OF EMBODIMENTS

The following description sets forth exemplary methods, systems, techniques, instruction sequences, computing machine programs, applications and the like. Such description is not intended as a limitation on the scope of the present disclosure but is instead provided as a description of exemplary embodiments. The purpose of the specific details in the explanation as presented are set forth for the purposes of understanding of various embodiments of the disclosed subject matter. It will be evident to those skilled in the art that the embodiments of the disclosed subject matter may be practiced with or without such details. The description does not show in detail all possible examples of protocols, structures, techniques etc. When operations are presented the presentation is not limited to specific order or sequence of operation or method steps as disclosed.

As presented herein, one or more embodiments disclosed herein are described in the context of an augmented reality (AR), application-based space (e.g., a room) design and decoration service for a user. As such, for purposes of the present disclosure, the term “user” will be used in reference to a potential consumer or person who is operating an AR capable mobile computing device which can execute an AR mobile application, in some physical, real world environment space (e.g., a room) in an effort to visualize that space which is enhanced with some added content such as products the user would be recommended and would like to have in the space.

In general, AR is the integration of digital information with the user's real-world environment in real time. An AR system may create a composite view for the user that is the combination of the physical space (or part of it) viewed by the user and a virtual scene generated by the computer that augments the scene with additional information. For example, a retailer would provide an application that lets the user view their room with a piece of artwork or a plant superimposed on the room, while the artwork for example has been chosen to fit the décor style of the room, the dimensions of the room or a part of it, and/or its type. If the room is a nursery, the artwork that will be proposed will be stylistically suitable to the room type, taking into account at least the color scheme of the room, the theme and/or the location of the proposed placement of the artwork by the application. In general, a variety of AR capable mobile computing devices (also referred to as “electronic device(s)”) are envisioned for use in the disclosed subject matter, such as smart mobile phones, tablet computers, head-mounted displays, AR headset and/or glasses with a built-in display, herein after “device” capable of performing the method of the disclosed subject matter.

Using the application in accordance with an example of the disclosed subject matter, a user can initiate an AR viewing session using a user interface on the device. During the AR viewing session, the mobile computing device uses input received from a combination of one or more image sensors and/or motion sensors to generate a representation that corresponds with the real world environment physical space in which the mobile computing device is being operated.

The representation is constructed via mobile sensors which may include streams of multiple types of data such as but not limited to RGB images, depth images obtained from 3D sensors, motion sensors, referred to herein as “image sensor”. It should be noted that depth images can be further obtained for RGB images using for example machine learning. This representation data, referred to hereafter as “real-world environment image”, is used to determine the position of the mobile computing device capturing the image relative to physical features of the space, objects and/or various surfaces and planes in the images being captured by the image sensor of the electronic device. It will be appreciated that the image sensor is capable of capturing a single image (e.g., a still image) or a sequence of images (e.g., a video stream) to represent the real-world environment image.

Furthermore, using computer vision and object recognition analysis, the image (or images) received from the user's device is analyzed to identify 3D features of the space such as floor, walls, obstacles, doors, windows, etc. which define the boundary of the room and objects such as a sofa, table, artwork, plants, lams etc. (and their attributes) present in the image. Accordingly, the information extracted from analyzing an image is used, to calculate boundary points of the scene to identify one or more designable areas (e.g., on a wall, on a floor, on a table) while taking into account the boundaries of the designable area to determine other areas and to query one or more databases of products to quickly and efficiently identify products that may be both complementary to those objects identified in the image, and suiting the style and type of the room in the image. It will be appreciated that while the application makes “automated” recommendations and suggestions for the designable area, the user may manipulate the suggestions switching between different product quantity, options and types.

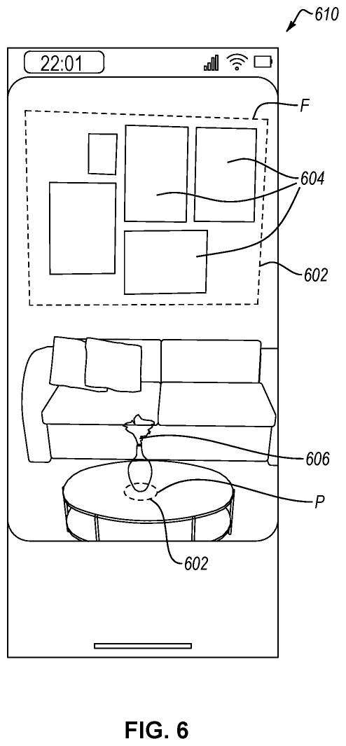

During the viewing session, the user of the AR mobile application can view a physical space, augmented with a designable area marking mask superimposed thereon and/or superimposed image(s) of product(s) selected and positioned by the user and proceed to purchase the product(s) chosen during the session using the same application, e.g., “in-app purchasing.” It will be appreciated that the designable marking mask may be a mask of a product, e.g., a generic representation of a product (e.g., plant, lamp, curtains, table, sofa, frame, etc.). Such a generic representation may be a hologram-like representation or a generic “blueprint” representation of the product category proposed by the application or as selected by the user from available options provided or supported by the application (seen in FIG. 6).

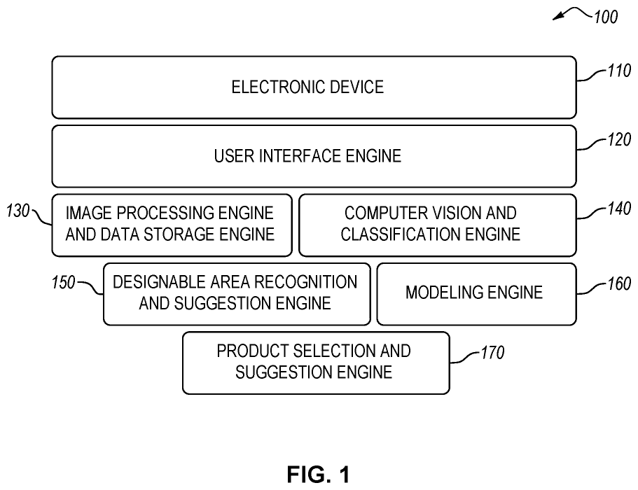

Other aspects of the disclosed subject matter will be readily appreciated from the description of the figures that follow. In the following, the components of an embodiment of a system for augmented reality layout 100 is described with reference to FIG. 1, in such manner that like reference numerals refer to like components throughout, a convention that we shall employ for the remainder of this description.

The components of the system described with reference to FIG. 1 may be embodied in hardware, software, or a combination of hardware and software, and similarly, the various components may be part of a single server computer system, or, may be part of a distributed system of networked computers. The system has three general layers comprising a front-end layer (e.g., user interface module), an application logic layer (e.g., servers used by the application), and a data layer (e.g., product data, preferences data, user generated data etc.).

In general, user interacts with the system using any one of a variety of AR-capable mobile computing electronic devices 110, such as mobile phones, tablet computers, head-mounted displays, glasses with a built-in heads-up display etc.

FIG. 1 is a system diagram illustrating the various functional components for suggesting recommended products in an AR environment that comprise an electronic device 110 that is an AR capable mobile computing device having one or more an image sensors, a display and a user interface 120 for the design application service. The application 100 facilitates the capturing and generating a representation of the real world environment scene using one or more image sensors of the electronic device 110 and through the user interface 120 presenting the scene on the display of the electronic device 110, as well as superimposing a layout (e.g., location, position, orientation etc.) of one or more designable area and upon user instructions through the user interface, a suggested placement of visual content (such as for offered products) in the designable area and a selection (of a product) in an AR view of the device, in accordance with some embodiments of the presently disclosed subject matter. As will be apparent from the described subject matter, the user through the user interface can switch between various products, adjust features of the product (e.g., frame color, frame size, content of artwork within a frame etc.), including an option to choose the number of products to be presented at the one or more designable areas based on the recommendations and options suggested to the user. It will be appreciated that the designable area can be represented in various modes, either visually represented on the user interface screen or idle on the device interface.

Various modules, electronic devices, and engines are referenced in the system 100 of FIG. 1 and throughout this disclosure. The modules, electronic devices, and/or engines described herein may be collectively or individually configured to carry out any of the example methods disclosed herein. Any modules, electronic devices, and/or engines described herein can comprise at least one processor, memory, a storage device, an input/output (“I/O”) device/interface, and/or a communication interface. In some examples, one or more of modules, electronic devices, and/or engines described herein may share a processor, memory, a storage device, an input/output (“I/O”) device/interface, and/or a communication interface.

In some examples, the processor(s) of any of the modules, electronic devices, and/or engines described herein includes hardware for executing instructions (e.g., instructions for carrying out one or more portions of any of the methods disclosed herein), such as those making up a computer program. For example, to execute instructions, the processor(s) of the modules, electronic devices, and/or engines may retrieve (or fetch) the instructions from an internal register, an internal cache, the memory, or a storage device and decode and execute them. In particular examples, processor(s) may include one or more internal caches for data. As an example, the processor(s) may include one or more instruction caches, one or more data caches, and one or more translation lookaside buffers (TLBs). Instructions in the instruction caches may be copies of instructions in memory or the storage device. In some examples, the processor may be configured (e.g., include programming stored thereon or executed thereby) to carry out one or more portions of any of the example methods disclosed herein.

In some examples, the processor is configured to perform any of the acts (e.g., analyzing, determining, processing, transmitting, generating) described herein in relation to the respective modules, electronic devices, and/or engines, or cause one or more portions of the modules, electronic devices, and/or engines to perform at least one of the acts disclosed herein. Such configuration can include one or more operational programs (e.g., computer program products) that are executable by the at least one processor.

The modules, electronic devices, and/or engines may include at least one memory storage medium. For example, the modules, electronic devices, and/or engines may include memory operably coupled to the processor(s). The memory may be used for storing data, metadata, and programs for execution by the processor(s). The memory may include one or more of volatile and non-volatile memories, such as Random Access Memory (RAM), Read Only Memory (ROM), a solid state disk (SSD), Flash, Phase Change Memory (PCM), or other types of data storage. The memory may be internal or distributed memory.

The modules, electronic devices, and/or engines may include a storage device having storage for storing data or instructions. The storage device may be operably coupled to the at least one processor. In some examples, the storage device can comprise a non-transitory memory storage medium, such as any of those described above. The storage device (e.g., non-transitory storage medium) may include a hard disk drive (HDD), a floppy disk drive, flash memory, an optical disc, a magneto-optical disc, magnetic tape, or a Universal Serial Bus (USB) drive or a combination of two or more of these. The storage device may include removable or non-removable (or fixed) media. The storage device may be internal or external to the modules, electronic devices, and/or engines. In some examples, storage device may include non-volatile, solid-state memory. In some examples, the storage device may include read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these. In some examples, one or more portions of the memory and/or the storage device (e.g., memory storage medium(s)) may store one or more databases thereon.

In some examples, computer-readable instructions may be stored in a memory storage medium such as one or more of the at least one processor (e.g., internal cache of the processor), the memory, and/or the storage device of the modules, electronic devices, and/or engines described herein. In some examples, the at least one processor may be configured to access (e.g., via a bus) the memory storage medium(s) such as one or more of the memory or the storage device. For example, the at least one processor may receive and store the data (e.g., look-up tables) as a plurality of data points in the memory storage medium(s). The at least one processor may execute programming stored therein adapted access the data in the memory storage medium(s) to automatically perform any of the acts described herein.

The modules, electronic devices, and/or engines described herein also may include one or more I/O devices/interfaces, which are provided to allow a user to provide input to, receive output from, and otherwise transfer data to and from the computing device. These I/O devices/interfaces may include a mouse, keypad or a keyboard, a touch screen, camera, optical scanner, network interface, web-based access, modem, a port, other known I/O devices or a combination of such I/O devices/interfaces. The touch screen may be activated with a stylus or a finger. The I/O devices/interfaces may include one or more devices for presenting output to a user, including, but not limited to, a graphics engine, a display (e.g., a display screen or monitor), one or more output drivers (e.g., display drivers), one or more audio speakers, and one or more audio drivers. In certain examples, I/O devices/interfaces are configured to provide graphical data to a display for presentation to a user. The graphical data may be representative of one or more graphical user interfaces and/or any other graphical content as may serve a particular implementation.

The modules, electronic devices, and/or engines described herein also may include a communication interface. The communication interface may include hardware, software, or both. The communication interface can provide one or more interfaces for communication (such as, for example, packet-based communication) between the modules, electronic devices, and/or engines or one or more networks. For example, communication interface may include a network interface controller (NIC) or network adapter for communicating with an Ethernet or other wire-based network or a wireless NIC (WNIC) or wireless adapter for communicating with a wireless network, such as a WI-FI.

Any suitable network and any suitable communication interface may be used. For example, the modules, electronic devices, and/or engines described herein may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the modules, electronic devices, and/or engines may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof. The modules, electronic devices, and/or engines may include any suitable communication interface for any of these networks, where appropriate.

The modules, electronic devices, and/or engines described herein may include a bus. The bus can include hardware, software, or both that couples components of the modules, electronic devices, and/or engines to each other. For example, the bus may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

Returning to FIG. 1, the system 100 comprises a collecting module having at least one environmental information collector (e.g., image sensor) for identifying and collecting an environment data in a reality viewpoint of the user, an image processing engine and data storage engine collectively designated 130, while it will be appreciated that these engines may comprise multiple modules some of which will be discussed hereinafter. The system further comprises a computer vision and object recognition engine 140, a designable area recognition and suggesting engine 150, a modeling engine 160 for modeling the layout of the designable area and products to be superimposed thereon and a product selection and suggestion engine 170.

In accordance with some embodiments, the image collecting, processing and management engine 130 receives individual image(s), or in some instances a sequence of images or video stream, from the electronic device 110, represents these in real time on the user display (e.g., the display device) through the user interface 120, stores these for processing in a database and processes these using the computer vision (CV) and classification engine 140. It will be appreciated that the engine 140 may comprise multiple modules functioning independently or simultaneously, in a sequence or in a cycle (e.g., using the one or more processing engines).

The image input is processed to identify 3D features which define the scene boundary (floor, wall, obstacles, objects etc.) and objects present therein, to map out the scene using the CV and classification engine 140, to classify the scene type, style, theme (indoor, outdoor, room, bedroom, nursery, living room, outdoor veranda etc., the materials, color scheme and design style of the real world environment, e.g., modern, classic, industrial, gothic, etc.). In addition, the system can perform value assessment for the quality of the captured environment to propose product categories and products that would suit the general style or theme of the environment (e.g., luxurious, affordable etc.). The data is stored in a data storing module and fed into the designable area recognition and suggestion engine 150 and to identify based on the end point boundaries of the processed features at least one area that is a candidate for decoration which is referenced herein as “designable area”.

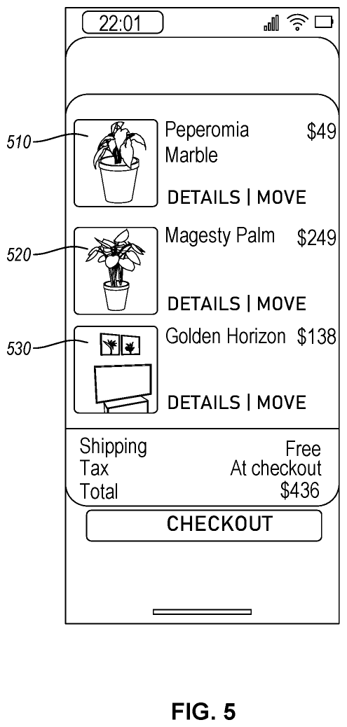

It will be appreciated that the designable area engine further preforms an analysis of all identified designable areas to ensure there is no overlap between these and further with any of the features of the scene in the image. Thus, one or more designable areas may be a free space on a wall at a height suitable for product placement (e.g., an artwork, shelves) between a TV set and a standing lamp (as will be further described in examples of screen shots seen in FIG. 5), a free space on a floor which could be suggested for a plant placement or a small carpet placement, a free space on a table etc.; while these suggestions are being made, the product selection and suggestion module 170 further runs a query to ensure no overlap of product suggestions is made to clash with the objects in the real world environment (e.g., if a TV is present, the engine may not suggest a TV set, if a designable area is near a lamp, the application may not suggest a lamp placement but for example a plant). However, it will be appreciated that the application may propose a replacement product in which case the designable area covers the area of the original product placement and when presenting the suggested product the area will be masked to cover over the original product and the suggested product will be overlaid thereon. Another exemplary feature is that the application may recognize that a certain original object is not placed in accordance with the interior design rules on which the applications holds instructions, and may propose removal or modification of the object or its placement (not shown).

The engine 150 further receives input from the CV and classification engine 140 on a type of the area identified as a candidate (e.g., wall, floor, table top etc.). The user interface is then presented with a 2D/3D layout of the designable area on the real-world scene displayed on the display of the device to the user and may present one or more suggestions on a type of product(s) compatible with the area identified as a candidate designable area. It will be appreciated that the designable area can be a feature recognized by the system and not represented on the user interface per se. In which case the system will present on the user interface a mask or a representation of the product (e.g., as seen in FIG. 6) per the following step. Upon an input from a user running a query to see product suggestions based on the presented layout, query is generated through the input module to the product selection and suggestion engine 170 (e.g., reality viewpoint augmenting module) to execute the instructions against a database of products while the modeling engine 160 provides renders of the suggested products positioned and oriented at the designable area maintaining position and orientation relative to the real-world scene. The product database can be on a remote server or locally downloaded to the device using the application. When on a local database, the product selection can be various catalogues provided by product creators' sellers.

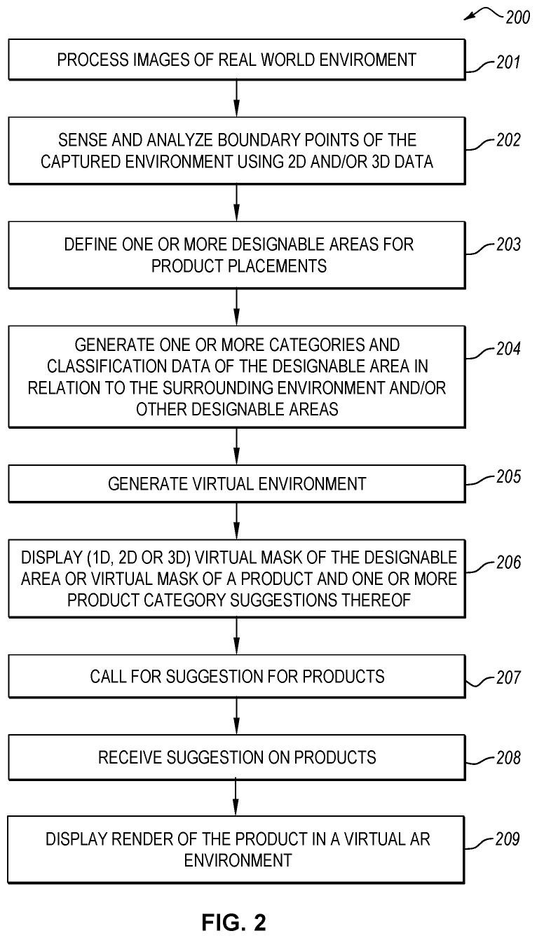

FIG. 2 is block diagram of an example system operations 200 for identifying and suggesting at least one designable area in an environment, in accordance with some example embodiments of the present disclosure. The system may receive for example an input from image sensor, the input being a scene of the real world environment captured in a single image or a sequence of images. At 201 one or more image processing engines 130 is configured to process the image(s) to identify, analyze and classify the 2D and 3D features of the scene using computer vision CV, machine learning ML and classification engines 140 and further store the data in a data storage module.

Next, in a system operation 202, the 2D and/or 3D data is analyzed to sense boundary points (boundary points as used herein refer to boundaries of the 2D and/or 3D features of the environment such as e.g., depth data, a wall, door, a floor, windows, obstacles etc. as well as objects and other products identified in the real world scene and further boundary points of the one or more designable areas when these are defined in operation 203.

In operation 203, the system using designable area recognition and suggestion engine 150 defines one or more designable areas for product placement taking into calculations at least the output of the operation performed at 202 and reiterating the process to ensure that any recognized designable areas do not overlap with any of the objects and features present the real world scene, any of the other designable areas and further that the designable areas follow the decoration rules given as instructions to the system (e.g., if a designable area is on the floor, that it will not obstruct access to any other objects nearby such as a door, if it's on a wall that the area is at a height suitable for example for hanging an artwork etc.).

At operation 204, the system generates one or more categories for the designable area and classifies the data (e.g., dimensions, location, orientation etc.) of the designable area in relation at least to the surrounding environment at the real-world environment scene and optionally other designable areas as identified by the system.

A virtual environment is further generated at 205 to allow a display of a virtual mask layout in one or more of the one dimension, two dimensions or three dimensions. The layout displayed by the system at 205 can be of the virtual mask of designable area the system recognized and defined using for example engine 150. For the one or more designable areas, the system may provide a display of one or more categories generated for the designable area at 204. It will be appreciated that the designable area can be a feature recognized by the system and not represented on the user interface as per step 206. In which case the system will present on the user interface a mask or a representation of a product following a query for product suggestion as discussed hereinbelow.

The system is further configured to initiate a query for product suggestion as seen at 207 based on the user input and selection from the suggested categories, and receive suggested products as an input in the form of small icons or images of the suggested products and its design variations to be displayed on the display using the user interface as shown in 208.

Upon selection of a product, the system is configured to execute a set of instructions to create using the modeling engine (e.g., 140) a render of the product that may be superimposed on the real world environment scene image on the display of the electronic device in a virtual augmented reality environment. Thus, the system makes it possible for the user to virtually view the positioning of the suggested one or more products and appreciate the compatibility with the desired design of the space, further allowing for changes, redesign etc., before actually placing the products in the physical environment. The system may further be provided with a module that allows the user to view a price of the recommended one or more products, adding the product(s) to a virtual shopping card and purchasing thereof. It will be appreciated that other features may be present in the system to allow suggestion of product(s), display, purchasing, sharing of the suggested design using applications connected to the application (electronic mail, text messaging, social media applications etc.) etc. In the latter the system may have a module for remote consultation by either sharing a screen or presenting the designable areas remotely on a remote device, displaying and purchasing of products from marketplaces or from the local database of products.

It will be appreciated that a consultation may be sharing of the real world environment images with before and after the virtual placement of the suggested products views. Such sharing can further be accompanied with a digital link to the suggested products and their attributes (category, size, shape, price etc.).

Sharing can also be in the context of location an installer for the suggested product which can further comprise a database of potential installers which are provided to the user with an option of communication with one or more of such installers through the system (not shown).

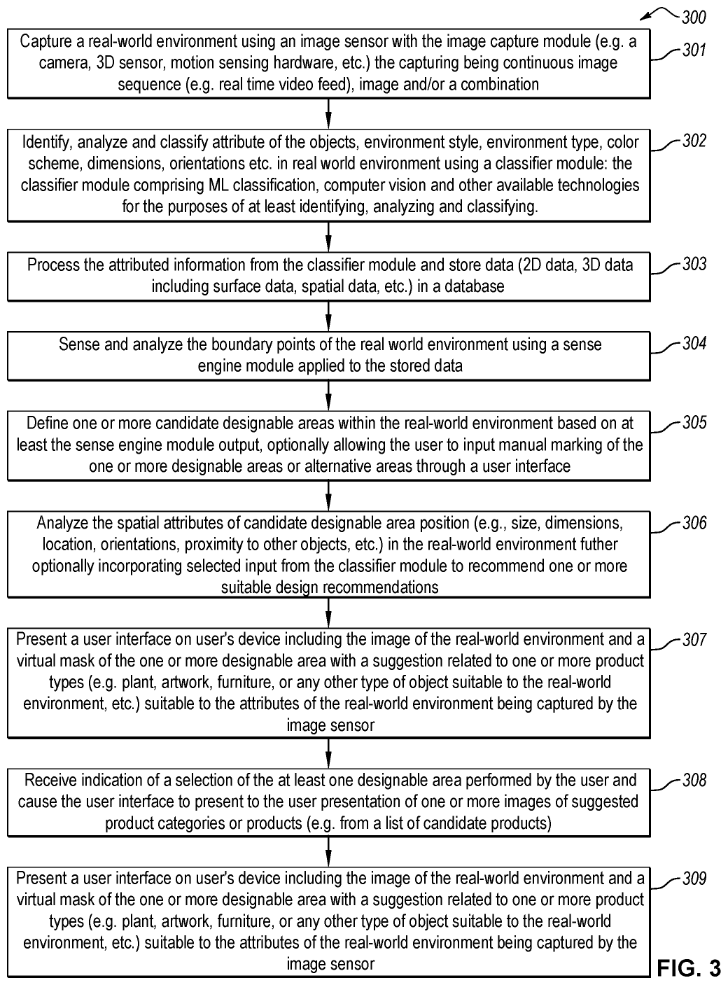

FIG. 3 is an example flow diagram of selected method operations 300 that occur when generating user interface suggestions for a virtual object (e.g., home furnishing, an artwork, carpet, plant, sofa, table etc.) in a real-world environment for placement in an AR view in accordance with some example embodiments of the present disclosure. It will be appreciated that while the method operations are discussed in a sequence, in accordance with certain embodiments of the disclosed subject matter the operations can be performed in varying order, e.g., in different sequence, a repetition of operations or loop based decision making by the processors until a desired outcome is reached. Such continuous feed allows the designable area to adjust based on the further scans of adjacent and\or other areas of the environment.

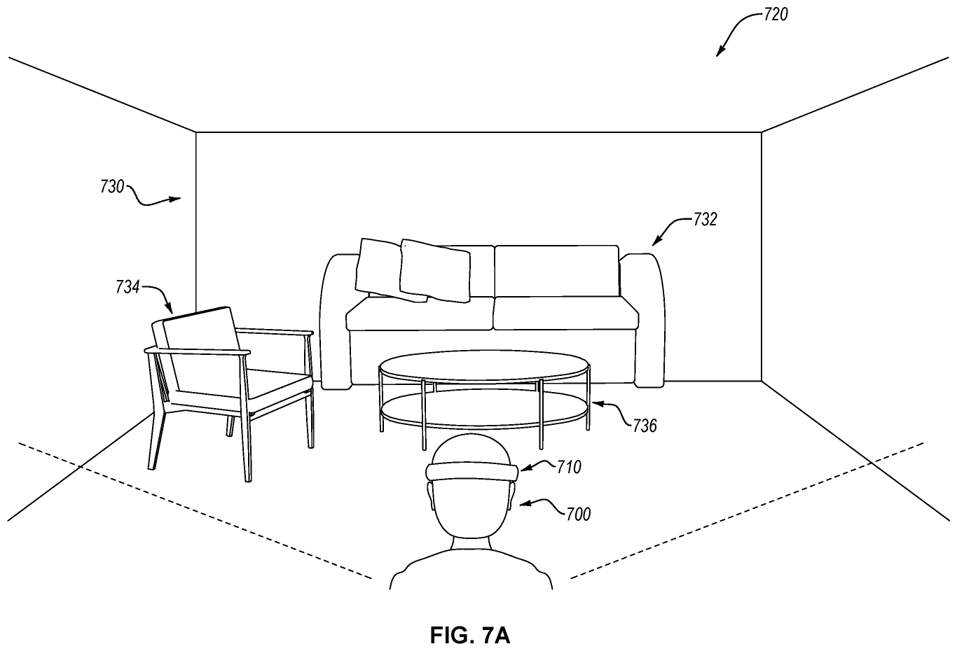

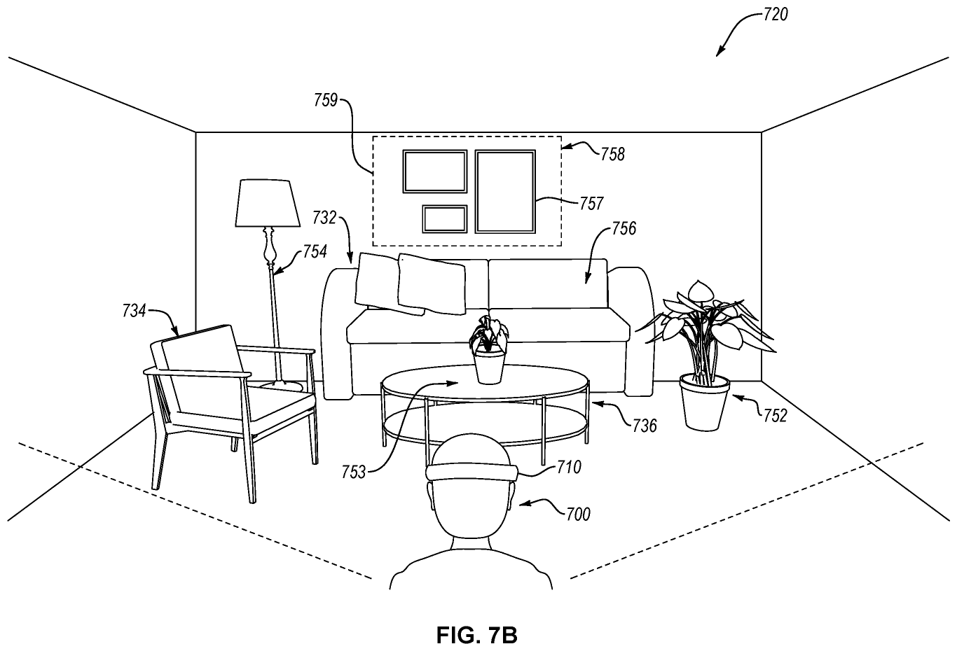

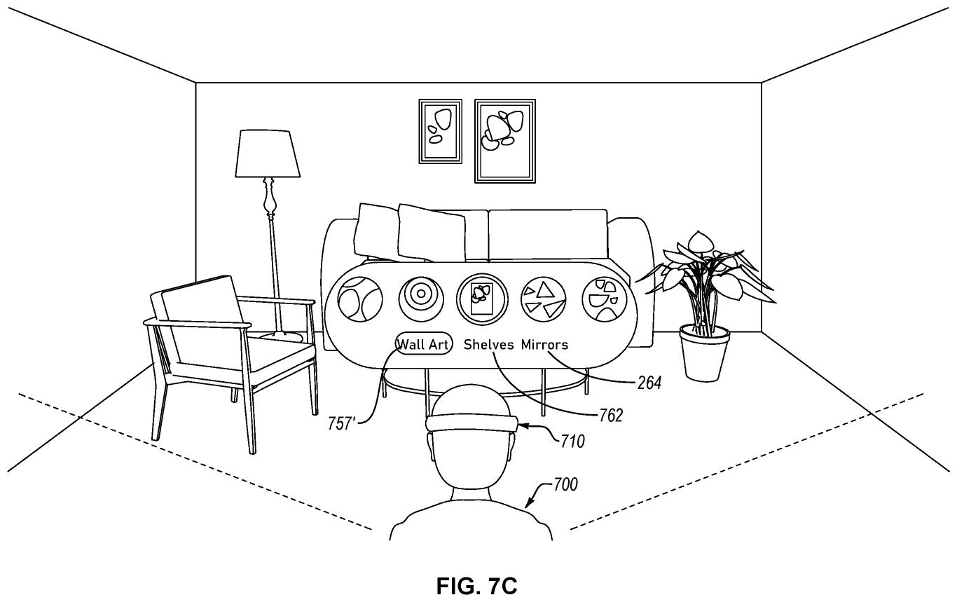

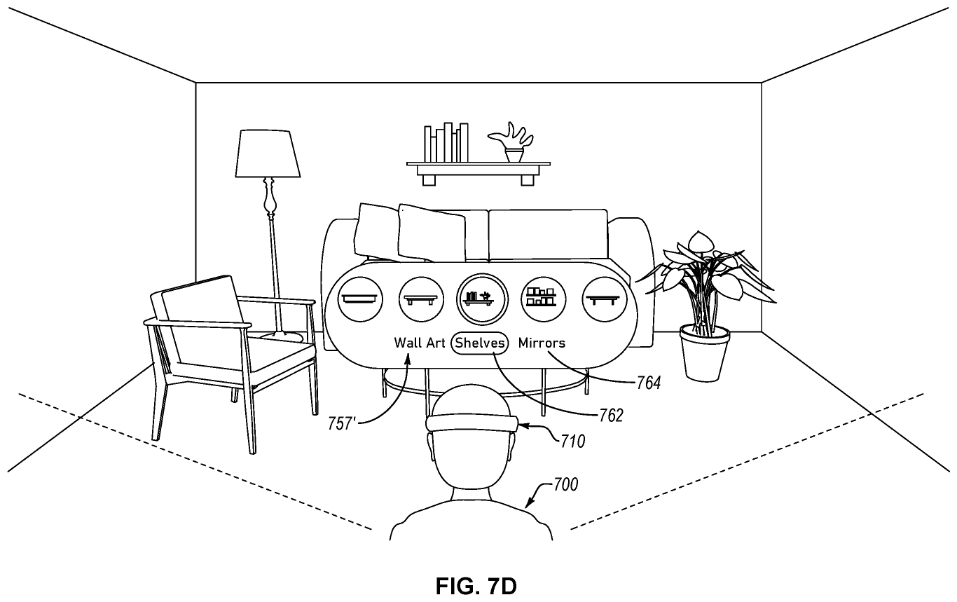

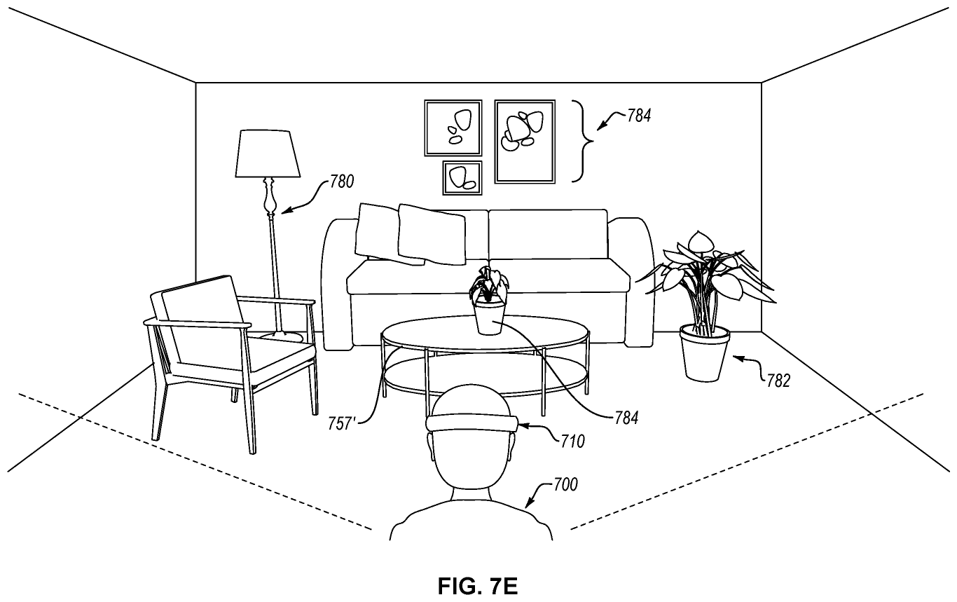

In accordance with some examples, a user initiates an AR application on their electronic device (e.g., mobile computing device such as a phone, an AR headset etc.) by selecting a user interface via the display of the device. The user directs the device and in particular the image sensor (e.g., a camera) towards a real-world environment on which the user desires to receive recommendation from the application (e.g., as seen in FIG. 7). Next, at step 301 the user using the device image sensor captures a real-world environment scene with an image capture module, the capturing being continuous (e.g., sequence of images with a real time video feed), fixed (e.g., a still image) or a combination of the two.

At 302, a server engine receives and stores an image (or images) as captured or derived with the image sensor on the electronic device 110 (e.g., using a module as shown in FIG. 1 referenced 130). It will be appreciated that the server can be a local server or a remote server or a combined server system. The image or images are identified, analyzed and classified for attributes of the objects, environment style, environment type, theme, color scheme, dimensions, orientations etc. in real world environment scene using an image processing, computer vision and/or classifier modules. It will be appreciated that this step may be performed continuously in real time. The image data may be stored in an image database.

In accordance with the disclosed subject matter the one or more CV and classification engines (e.g., feature identified as 140 in FIG. 1) may execute a machine learning object recognition and classification protocols, computer vision recognition and mapping protocols, and other available technologies for the purposes of at least identifying, analyzing and classifying the objects and 3D features of the real world environment scene as captured by the one or more image sensors.

At the next step 303 the data from the images as classified is analyzed and processed for yielding an output comprising the attributed information of the real world scene in the image(s) and stored (e.g., as 2D data, 3D data including data of the 3D features, surface data, spatial data, etc.) in a database.

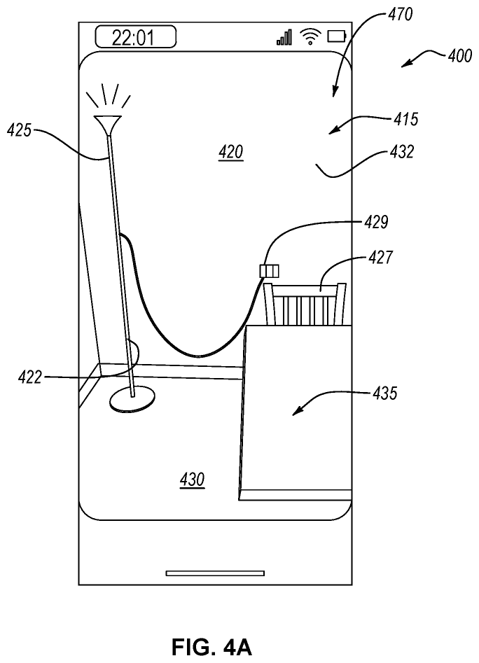

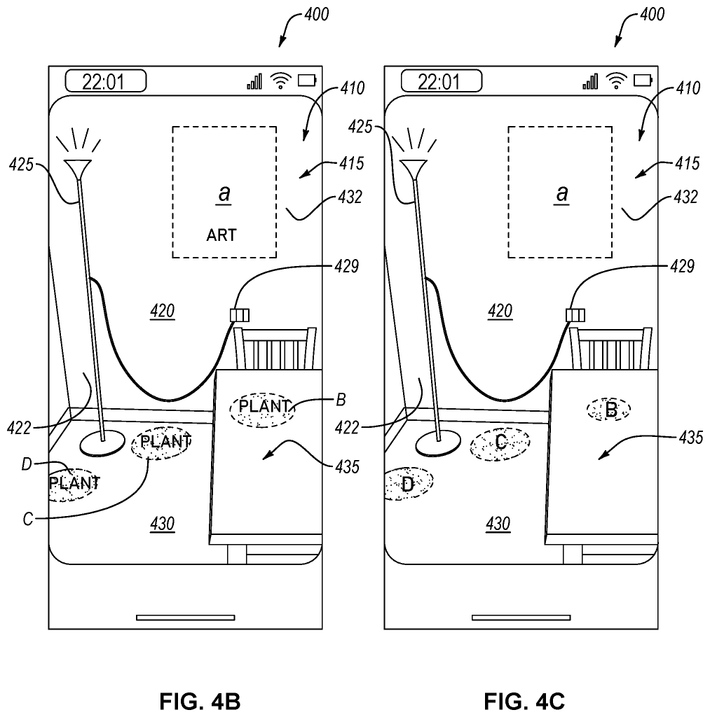

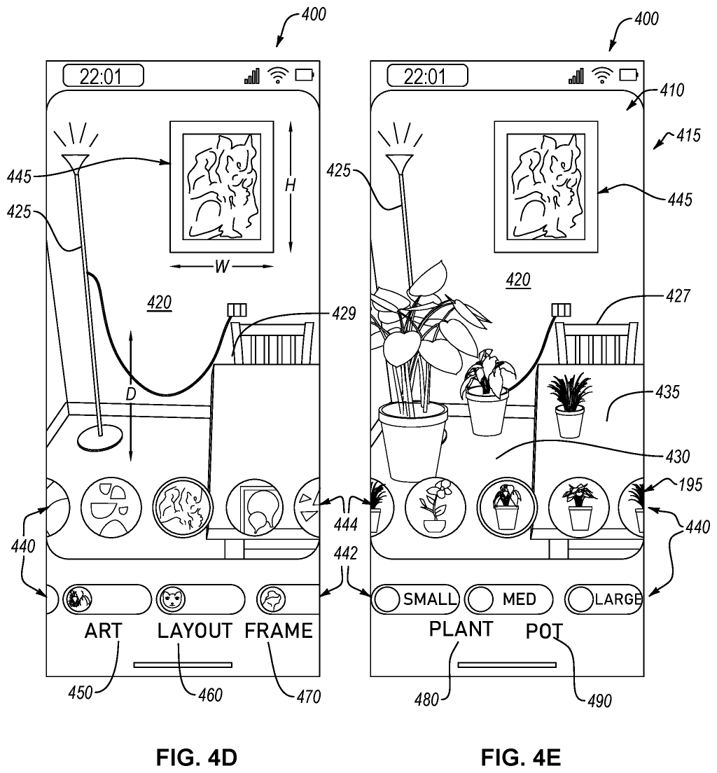

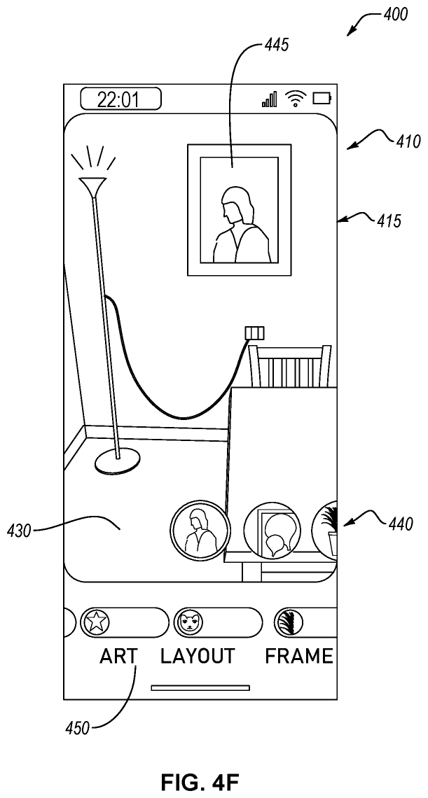

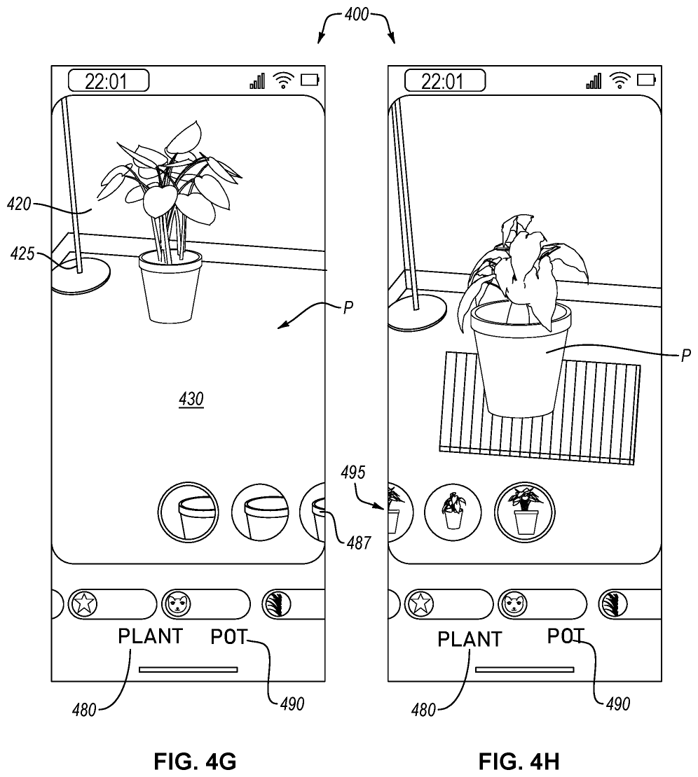

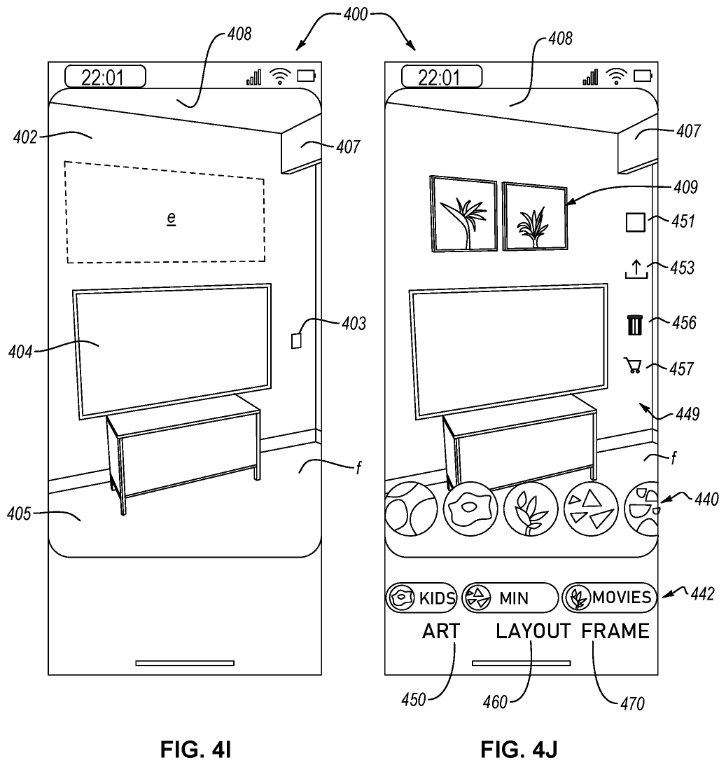

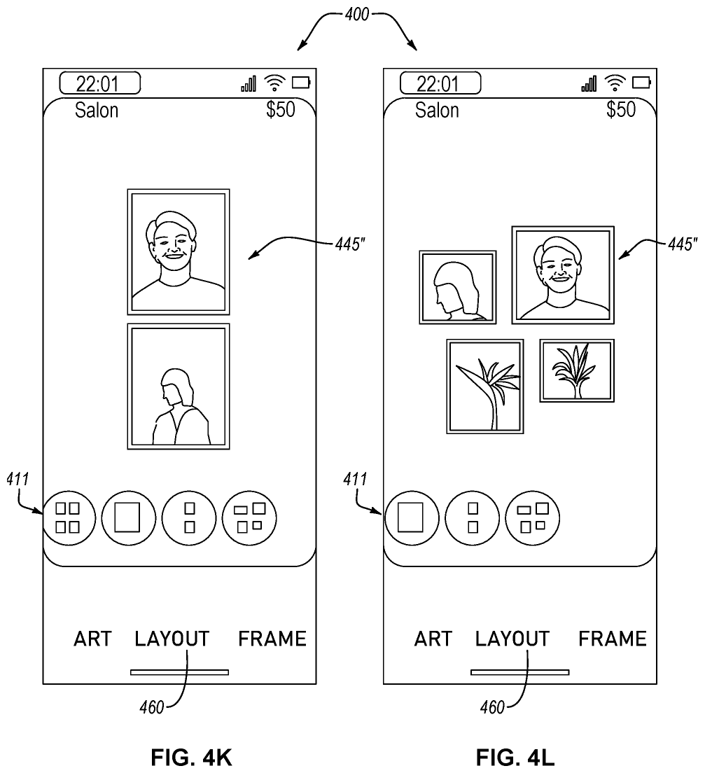

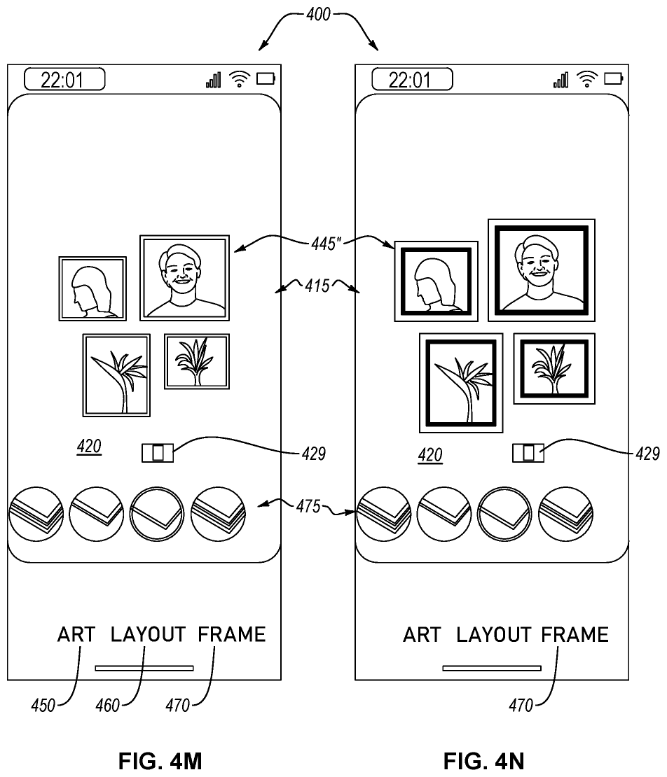

At method operation 304, boundary points of the attributes in the real world scene data are analyzed to identify, using a sense engine (as seen in FIG. 4), the boundary end points of various objects and 3D features in the scene, to identify a 2D (e.g., a wall space, or a floor space) or 3D areas (e.g., a space on a floor or a table), depth data etc., which are candidate designable areas for further product placements. It will be appreciated that in accordance with the disclosed subject matter, the application may allow the user to input manual marking on the real world scene image of the one or more designable area or alternative area through a user interface on the device.

Next, at 305 one or more candidate designable area within the real-world environment are defined as an output based on at least the sense engine module output. The output (candidate designable area) is analyzed at method operation 306 for its spatial attributes (e.g., size, dimensions, location, orientations, proximity to other objects, etc.) relative the real-world environment scene data of operation 302 and other designable areas based on the data from 304. Based on the analysis it may be determined what product category (one or more) is suitable for the designable area (e.g., if the designable area is on the wall, a product category may be shelves, artwork etc.) if a table or other furniture present it may propose placement of related product category thereon (e.g., plant, lamp, tablecloth, tableware etc.) or under (e.g., a carpet). At 307 the application method may present on user's device the image(s) of the real-world environment and a virtual mask layout of the one or more designable area (or virtual mask of product category) with or without a suggestion (one or more) related to one or more product types suitable to the attributes of the real-world environment being captured by the user. Optionally, the system may present the user with a virtual mask (e.g., “blueprint”, hologram, generic representation etc.) of the product at the designable area to allow the user to visualize the proposed product category (seen in FIG. 6). The user is further allowed to manipulate the scene by moving the virtual mask of either the designable area or the virtual product representation (mask or render).

At method operation 308, upon receiving an indication of a selection by the user of the at least one designable area recognized and/or suggested in 307, a query is generated using attributes of the category and type of product recommended for the designable area and executed against a database of products to identify and present to the user on the user interface a set of candidate product images.

At method operation 309, upon user indication of a selection of the product, the product is rendered on the virtual designable area and superimposed over the real world environment scene as represented on the display of the user using an AR mode on the user interface. It will be appreciated that the product selection and placement options being further manipulatable by the user through manual input using the user interface; the placement option being relative the designable area and corresponding to the real-world data identified by the image sensor. Variations of placements are presented to the user until the user confirms the placement and may proceed to e.g., purchasing the recommended product(s) using the application by adding the product to the online shopping cart (not shown).

Turning now to FIGS. 4A-4N, examples of user interfaces in accordance with examples of the disclosed are presented. These user interfaces implement exemplary embodiments of the presently disclosed subject matter. FIG. 4A is an example of the real-world environment image 410 as captured by the image sensor on a user's device 400 (e.g., a smart mobile phone) and displayed on the devices display 415 which in the present example is a touch screen display. The device comprises the system components as discussed with reference to FIG. 1. The image 410 shown is a frame of a live video that is displayed on the user's device 400. The image as shown comprises a wall 420 and a floor 430, a corner protrusion 422 from the wall 420, a lamp 425, a table 435 seen at a distance from a wall, a chair 427 and a portion of window frame 432. The user activates the system components (e.g., as discussed with reference to FIGS. 1 and 2) and initiates the method operations as discussed (e.g., with reference to FIGS. 2 and 3). Upon initiation of the one or more methods, the image processing engine 130 is activated to identify, analyze and classify the type of room in 410 using the CV and classification engine 140. Furthermore, 3D features (e.g., height h, width w, depth D, 420, 430, 422, 432) of the room in image 410 are detected as are various objects therein (e.g., 425, 435, 427).

FIG. 4B shows designable areas being virtually masked over the image 410. As can be seen, four designable areas a, b, c, d are suggested through the user interface to the user on the display 415. Designable area a in the form of a rectangle is suggested on the wall 420 by being superimposed over the wall in a virtual environment using an AR application. The dimensions of the designable area a are configured to correspond the free wall space between the lamp 425 and the window frame and at a distance from the floor and the electric socket 429. The designable area a was defined by the system as suitable for an artwork e.g., as described in reference to FIG. 2, by sensing and analyzing the boundary points of the environment in the image, including the 3D features therein, the heights, width, depth etc. For example, in the case of the designable area a, the system may sense the boundary points of e.g., the floor, the wall, the lamp, the socket, the protrusion 422, the window frame 432 and following an analysis of these define an area as a candidate for design. In case of the designable areas c and d for example, at least the floor 430 and the lamp 425 as well as distance from the wall 420 are taken into consideration as boundary points for analysis and defining of the designable area, its dimensions, orientation and location. It will be appreciated that various design rules and instructions could be implemented by the systems for defining designable area in a space or on a surface as described herein and these may be defined on the application based on preferences, e.g., cultural, national, geographical etc. For example, for the designable area, the system further assess the dimensions and location of the designable area to correspond to the acceptable rules for positioning items on a wall, e.g., the height being at the center of eye height, or covering the wall surface with 60-40 ratio, etc.

FIG. 4C illustrates designable areas as in FIG. 4B, however the designable areas in FIG. 4C are provided with a category of recommended product for the designable areas (in this example “art” and “plant”), the category being generated e.g., as described in connection with operation method 306 in FIG. 3. While in this illustration only one category is presented for each designable area, it will be appreciated that multiple suggested categories may also be presented (not shown). For example, for designable area a, a further category e.g., “shelves” or “clock” or “mirror” may be presented.

As seen in FIG. 6, the real world environment image 610 is provided with two designable areas F and P. The designable areas F and P are marked in dashed lines 602 with the proposed product category (Artwork and a Plant) being presented thereon by a virtual mask 604 and 606 in a generic form. Upon user's choice of one or both of the areas F and P, the system will pull up icon buttons for the selection of the artwork or the plant suggested by the system as will be discussed herein after with reference to the example in FIGS. 4 and 5.

FIG. 4D illustrates a user interface showing icon buttons 440 for selection of various artworks and icon list for types of artworks “abstract” “animals” “anime” etc. The user having chosen the designable area a is presented with the selection of the icons 440 which include in this example two rows of icons-one directed to the art type 442 (e.g., “abstract” “animals” “anime” etc.) and another row 444 displaying at least extracts of corresponding art images as suggested to the user based on the product selection options and compatibility to the room type and style as identified by the system.

Upon user input of the choices for the type and the artwork the display with present renders 445 thereof over the designable area, the renders being generated by the modeling engine discussed e.g., in FIG. 1. Thereby the user can see on the display 415 in an AR virtual environment the art work 445 which is superimposed over the image 410 and appreciate how the artwork 445 will appear on the wall 420 in the scene, its compatibility to the overall décor of the room, etc., and choose the one most suited for the user's preference. FIG. 4F illustrates a different artwork 445′ selected by the user to be presented in the AR virtual environment over the same designable area a. As will be further discuss, the interface presents to the user (e.g., through the modeling engine discussed in reference to FIG. 1) choices for the art 450, the frames 470 and the layouts 460 that the user can switch by engaging the respective icon buttons on the display while the engine will render the choices and present the selection in the AR environment as superimposed on the designable area in the virtual environment.

FIGS. 4E and 4F further illustrate plants as being selected for designable areas b, c and d, each plant being individually selected by the user based on the product selection and types of products, in this case plants, as presented to the user in icon buttons on the user interface, the icon button presented allowing the user to switch between different plant types 480 and different pots 490 for each plant such as in the previous example, the system renders the chosen designs and superimposes them in the AR environment as virtual products while presenting in icon buttons a preview of the choice in a neutral environment 495.

FIG. 4G illustrates an example of the user interface display where the embedded system is zooming-in on the designable area (e.g., designable area c) and the user interface presents the user with options for selection of plant type 480 (e.g., seen in FIG. 4H with respect to a different designable area but following similar principles and operation method steps) and pot types 490 (e.g., FIG. 4G). As in the previous examples, the display shows small previews 497/495 of the choices available for selection on the icon buttons allowing the user to appreciate the general look of the product before the model is rendered to the scene. It will be appreciated that the user can switch between the choices after a render has been displayed in the AR environment and see a different type, style or category of the products in said environment.

FIGS. 4I and 4J illustrate a different environment as captured by a user's device, showing a designable area e on a wall surface 402 above a TV screen 404. For example, in the case of the designable area e, the system may sense the boundary points of e.g., the floor 405, the wall 402, the dimensions and 3D features such as a TV screen 404, the socket 403, the wall protrusion 407 extending from the ceiling 408, the ceiling, and following an analysis of these as well as the depth, heights, width etc. of scene define an area as a candidate for design-here a designable area e and designable area f on a floor near what appears as a corner of the room in a vicinity of the TV screen. As discussed herein, these 3D and 2D features are taken into consideration as boundary points for analysis and defining of the designable area, its dimensions, orientation and location as well as for identifying at least one category for the designable area.

FIG. 4J illustrates the user interface with the recommendation and selection icon buttons 440, 442, 444, 450, 460, 470, in the exemplified case, for artwork. Other buttons 449 can be presented on the screen or on menus accessible by the user such as product info 451, prices (not shown), sharing with a third party (453), deleting 456, “add to cart” 457 (which will be further discussed with reference to FIG. 5), etc. It will be appreciated that the system further analyzes the room for a room type and a room style (e.g., using the ML, CV and classification engines discussed with reference to FIG. 1,2, or 3). As seen in FIG. 4J, the user has chosen from a layout option selection icons 460 a grid of two artworks 409. Examples of other grid types 411 are further seen in FIGS. 4K and 4L and identified as 445″ and 445′″. Thus, while a designable area e is presented as a continuous virtual mask in FIG. 4I, the user may be presented with a recommendation of one single artwork suitable for the dimensions of the designable area or a grid or artworks allowing the user to choose between one or more layout options as well as artworks compatible to the designable area and the layout based further on the type and style of the room as captured by the image sensors. In general, layout may be calculated and suggested based on the designable area alone or while calculating the overall area, e.g., in case of a wall the wall dimensions, the distance from other objects, and design rules such that the layout proposed is suitable to the area identified as designable area. Upon executing a choice, the virtual AR environment will present the user with renders of the chosen products which the user can change upon making a further selection through the icon buttons on the user interface display.

As further seen in FIGS. 4M and 4N, the user can choose between recommended art 450, layout 460 thereof in grids or otherwise, and/or frame design options 475 through associated icon buttons for each of these. It will be appreciated that while the exemplary embodiments of the user interface have been shown with icon buttons, other means for user input could be used. One such input can be eye movement tracking and/or hand gestures when using an AR headset (e.g., as seen in FIG. 7).

It will appreciated that the application can provide the user with either a fixed dimension frames or other products or can propose site specific frame dimensions that would be suited to the designable area and the overall real world environment being designed. In this connection, while the reference is made to one or more frames, modularity of the products that could be proposed to the user apply to other product categories, such as shelves or shelving systems, sofa or living room arrangements, tables, garden decks, etc.

Upon selection of the products for one or more of the designable areas, as seen in FIG. 5, the user is directed to an online shopping cart interface where they can proceed to purchasing one or more of the recommended products suitable to the user preferences and as selected through the user interface described with respect to the examples described. The items as appearing in the cart 510 (plant), 520 (plant), 530 (artworks) are represented as they would appear in the real world environment and are captured upon confirmation of the client of the selected product suggestion. Upon completion of purchasing and even while holding the items in the cart, the suggested placement is recorded and may be sent to the user. The information may further include measurements (e.g., for placement). In accordance with another example, for AR headset or mobile device with AR embedded features the user can project on the wall the suggested placement and install the suggested products according to the projection when the products are in their possession. The listed items in the cart are optionally further provided with a “details” button which upon activation provides a pop-up screen with e.g., details about each item, instructions for care, placement, reviews, grading by other users, etc. The selection further comprises a “remove” button in case the user no longer wished to purchase the item.

Attention is now directed to FIGS. 7A-7E providing an example of the system and method in accordance with an example of the disclosed subject matter, a user 700 using a head-mounted device with a display 710 to perform the steps discussed in connection with previous examples herein. The figures present examples of screens 720 as seen by the user 700 using the device, the device capturing and presenting via the head mounted device the he perceived field for the user to decorate. FIG. 7A shows the screen as seen by the user with the room shown as a real world environment image 730 as captured by the image sensor on the user's 700 device 710. The environment, the room, comprises a sofa 732, armchair 734, coffee table 736. In FIG. 7B it is shown that the system recognized multiple designable areas in the environment showing these to the user as a mask of the designable areas and blueprint of product categories. The system proposed placing plant 752, lamp 754 at the sides of the sofa 732, pillows 756 on the sofa, wall art 758 above the sofa and a small plant 753 on the coffee table. The wall art mask 758 is presented with an option of three frames 757 arranged within the designable area 759. As discussed in connection with previous examples, the user can alter the dimensions, move, rearrange or completely disregard the suggestions of the designable area by the system. FIGS. 7C-7D show some of the following steps of the user 700 using the system over the head mounted device 710. The user using the device gesture or selection feature selects for the desired designable area the product he would like to see visualized prior to purchase. As discussed, this allows the user to visualize the real world environment with the proposed or chosen products prior to actual purchasing or installation, allows optionally sharing with others, comparing various products and product categories etc. FIG. 7C illustrates the selection option as seen by the user for the designable area above the sofa. The System after recognizing and classifying the space for the designable area proposes placement of wall art 757′ (see button “wall art”), shelves (see button “shelves”), mirrors (see button “mirrors”), etc. By selecting the product category the user is presented with the augmented real world environment (e.g., as seen in FIG. 7D the user by selecting the shelves button from the menu is presented with the augmented wall representation carrying the shelves with ornaments thereon. Upon completion of the selection process the user can be presented with the final representation of the augmented view of the real world environment with the chosen products by the user (seen in FIG. 7E), where the user has chosen a lamp 780. A plant 782 on the floor near the sofa side, a wall art composition comprised of three frames 784, and a small plant 784 on the coffee table in front of the sofa. The sofa is augmented by placement of the pillows, coordinated in color scheme with the rest of the environment.

While various aspects and embodiments have been disclosed herein, other aspects and embodiments are contemplated. The various aspects and embodiments disclosed herein are for purposes of illustration and are not intended to be limiting.

1. A system, comprising:
an image sensor configured to generate an image sequence comprising at least one image;
a display device;
one or more processing engines; and
a data storing module coupled to the one or more processing engines;
wherein the data storing module includes computer-executable instructions that, when executed by the one or more processing engines, cause the one or more processing engines to perform operations including:
displaying on the display device the image sequence of a real-world environment;
generating a virtual masking of one or more designable areas on the image of the real world environment as displayed, the virtual masking being generated by processing using at least one of a computer vision and classification processing engines the real-world environment data of the image sequence, analyzing and sensing boundary points of the real-world environment data in at least two dimensions, and identifying, using at least said boundary points, spatial attributes of the one or more designable areas, the virtual masking being displayed at least in two-dimensions, the virtual masking further configured to present product category based on said spatial attributes;
transmitting, to a server, a request specifying a product category of items that have dimension values that fit the dimensions of the virtual masking of the one or more designable areas;
displaying, on a user interface in the display device, one or more items matching the one or more designable areas as defined; and
following a selection of an item from the one or more items, displaying, on the display device, a modified image sequence that shows the image sequence and one or more 3D renders of the selected item as arranged at the virtual masking.

2. The system in accordance with claim 1, wherein the image sensor is configured to collect data including dimensions of the real world environment.

3. The system in accordance with claim 1, wherein the image sensor includes a camera.

4. The system in accordance with claim 1, wherein the display device includes a computing device.

5. The system in accordance with claim 1, wherein data collected and generated by the image sensor includes image data of the real world environment, wherein physical dimensions are derived from the image data in the at least one image.

6. The system in accordance with claim 5, wherein the data includes 3D feature data, and wherein the computer-executable instructions, when executed by the one or more processing engines, cause the one or more processing engines to determine dimensions of the real world environment based on the 3D feature data.

7. The system in accordance with claim 1, wherein the one or more processing engines include a recommendation engine configured to provide a product recommendation based at least on the candidate product category.

8. The system in accordance with claim 1, wherein the one or more processing engines include a recommendation engine configured to select and provide a product recommendation based at least on a profile of a system user.

9. The system in accordance with claim 1, wherein the one or more processing engines include a recommendation engine configured to select and provide a product recommendation based at least on a past purchase history of a system user.

10. The system in accordance with claim 1, wherein the one or more processing engines include a recommendation engine configured to select and provide a product recommendation based at least on a merchant product availability.

11. The system in accordance with claim 1, wherein the virtual masking of the one or more designable areas is a generic representation of the at least one product from a product category presented based on the spatial attributes.

12. The system in accordance with claim 1, wherein the computer-executable instructions, when executed by the one or more processing engines, cause the one or more processing engines to allow the one or more designable areas to be manipulated by a user.

13. The system in accordance with claim 12, wherein the manipulation of the one or more designable areas comprises at least one of moving thereof, altering size and dimension, and/or changing the product category through an input module.

14. The system in accordance with claim 1, wherein the one or more processing engines include a module configured to allow sharing the modified image sequence.

15. A computer-implemented method, the computer-implemented method comprising:
displaying, on a display device of a user device, an image sequence depicting a real-world environment, the image sequence generated using an image sensor of the user device;
generating, on the user device, a virtual masking of one or more designable areas on the image of the real world environment as displayed, the virtual masking being generated by processing, using at least one of a computer vision engine and/or a classification processing engine, the real-world environment data of the image sequence, analyzing and sensing boundary points of the real-world environment data in at least two dimensions, and identifying, using at least said boundary points, spatial attributes of the one or more designable areas, the virtual masking being displayed at least in two-dimensions, the virtual masking further configured to present a product category based on said spatial attributes;
transmitting, to a server, a request specifying the product category of items that have dimension values that fit the dimensions of the virtual masking of the one or more designable areas generated on the user device;
displaying, on the user interface in the display device, one or more items matching the one or more designable areas as defined; and
following a selection of an item from the one or more items, displaying, on the display device, a modified image sequence that shows the image sequence and one or more 3D renders of the selected item as arranged at the virtual masking.

16. A computer implemented interior decoration system operable by a user, the computer implemented interior decoration system comprising:
a collecting module for identifying an environment data in a reality viewpoint of the user, comprising at least one environment information collector;
at least one processing module configured to receive the data from the collecting module and identify an area candidate for design;
an input module configured to receive optional input from the user to manipulate the area candidate for design; and
a module configured for augmenting the reality viewpoint with a virtual masking of said identified candidate area for design, presenting the augmented view to the user and configured to provide at least one suggestion on one or more candidate product categories suitable for the identified candidate area for design;
wherein the module for augmenting said reality viewpoint being further configured to present to said user an image of at least one virtual product from the one or more candidate product categories, thereby providing an augmented reality viewpoint of said reality viewpoint comprising the at least one virtual product in said identified candidate area for design.

17. A computer implemented interior decoration method for providing an augmented reality viewpoint to a user, the computer implemented interior decoration method comprising:
identifying and collecting, by at least one module, a real-world environment data in a reality viewpoint of the user, using at least one environmental information collector for detecting and collecting two and/or three-dimensional information of the environment;
processing the data from the at least one information collector module to identify an area candidate for decoration;
augmenting the reality viewpoint with a virtual masking of the identified candidate area for decoration; and
presenting the augmented reality viewpoint with the identified candidate area to the user and providing, using at least one processing module, at least one suggestion on one or more candidate product categories suitable for said identified candidate area for decoration; said predicting based on at least one of the suggested product categories being complementary to the identified reality viewpoint and at least a location, dimensions and characteristics of said identified candidate area.
